(19) United States
(12) Patent Application Publication
(10) Pub. No.: US 2026/0121166 A1
(43) Pub. Date: Apr. 30, 2026

(54) IMMERSION COOLING MODULE AND CONTROL METHOD USING SAME

(71) Applicants: SK INNOVATION CO., LTD., Seoul (KR); SK ENMOVE CO., LTD., Seoul (KR)

(72) Inventors: In Sik JUNG, Daejeon (KR); Gi Hong MIN, Daejeon (KR)

(21) Appl. No.: 19/367,825

(22) Filed: Oct. 24, 2025

(30) Foreign Application Priority Data
Oct. 30, 2024 (KR) 10-2024-0150971

(51) Int. Cl. H01M 10/6568; H01M 10/613; H01M 10/633

(52) U.S. Cl. CPC H01M 10/6568; H01M 10/613; H01M 10/633

(57) ABSTRACT

An immersion cooling module and a control method using the same are provided. The immersion cooling module includes a receiving unit in which a cooling fluid is contained and in which a battery cell is immersed, a support unit which partitions the receiving unit into a first space in which a first cooling fluid is contained at one side and a second space in which a second cooling fluid is contained at the other side, and to which at least one battery cell is coupled, and a circulator coupled such that the first space at one side of the support unit and the second space at the other side of the support unit are connected to communicate with each other, thereby allowing the first cooling fluid and the second cooling fluid to flow with each other.

### CROSS REFERENCE TO RELATED APPLICATION

The present application claims priority to Korean Patent Application No. 10-2024-0150971, filed on Oct. 30, 2024, the entire contents of which are incorporated herein for all purposes by this reference.

### BACKGROUND

### Technical Field

The embodiments of the present disclosure relate to an immersion cooling module and a control method using the same.

### Description of the Related Art

Recently, as mobile information terminals such as mobile phones and laptops have become smaller and lighter, and as higher capacity is required for electric vehicles and hybrid vehicles, various batteries have been developed and used as power sources.

As the efficiency of secondary batteries becomes increasingly important depending on their application, some problems arise due to various external environments, such as heat generation and fire during charging or discharging battery operations.

Accordingly, various technologies have been developed to improve the operational efficiency of such secondary batteries and to ensure their safety. In addition, there is a growing demand for more efficient mechanisms for operating devices, and for improving cooling methods and maximizing efficiency, due to the recent increase in carbon emissions and global warming caused by the recent surge in electricity consumption.

### SUMMARY

According to an embodiment of the present disclosure, there is provided an immersion cooling module capable of effectively maintaining the cooling performance of cooling fluids through the flow of the cooling fluids in a separate space in which the inflow and outflow directions of the cooling fluid for cooling a battery cell are different from each other.

According to another embodiment of the present disclosure, there is provided a control method for an immersion cooling module capable of maximizing the cooling performance of cooling fluids by appropriately controlling the flow of the cooling fluids and the flow direction thereof in a separate space in which the inflow and outflow directions of the cooling fluid for cooling a battery cell are different from each other.

An immersion cooling module according to an embodiment of the present disclosure may include a receiving unit in which a cooling fluid is contained and in which a battery cell is immersed, a support unit which partitions the receiving unit into a first space in which a first cooling fluid is contained at one side and a second space in which a second cooling fluid is contained at the other side, and to which at least one battery cell is coupled, and a circulator coupled such that the first space at one side of the support unit and the second space at the other side of the support unit are connected to communicate with each other, thereby allowing the first cooling fluid and the second cooling fluid to flow with each other.

Herein, the battery cell may be coupled to the support unit, and a porous moisture-absorbing member may be further included between a coupling surface of the support unit and the battery cell.

In addition, the circulator may include a first screw formed in a region of the first space, a second screw formed in a region of the second space, a rotation shaft in which the first screw and the second screw are coupled, and a support plate having at least one through-hole formed therein in which the first space and the second space are connected to communicate with each other by allowing the rotation shaft to be rotatably coupled to a driving device and the driving device to be coupled to the support unit.

In addition, further included are a first inlet unit through which the first cooling fluid is introduced in one end of the first space, a first outlet unit through which the first cooling fluid is discharged in the other end of the first space, a second inlet unit through which the second cooling fluid is introduced in one end of the direction in which the first outlet unit of the second space is formed, and a second outlet unit through which the second cooling fluid is discharged in the other end of the direction in which the first inlet unit of the second space is formed.

In addition, the through-hole of the support plate may be formed in a circular shape in a plurality along a circumferential direction of the support plate.

A control method for an immersion cooling module according to an embodiment of the present disclosure may include measuring a temperature respectively at a first space side and a second space side of a plurality of circulators that connect a first space containing a first cooling fluid and a second space containing a second cooling fluid to communicate with each other, determining whether a temperature difference between the first space side and the second space side exceeds a predetermined threshold, driving a first circulator when the temperature difference between the first space side and the second space side exceeds the predetermined threshold such that the first circulator at a point where the temperature difference is measured can allow the first or second cooling fluid of the first space side or the second space side where the temperature is lower, to flow into the second space side or the first space side where the temperature is higher, and driving a second circulator adjacent to a direction in which the second cooling fluid or the first cooling fluid flows from a second inlet unit to a second outlet unit or from a first inlet unit to a first outlet unit in the second space side or the first space side where the temperature is higher such that the second cooling fluid or the first cooling fluid can flow in a direction from the second space side or the first space side where the temperature is higher to the first space side or the second space side where the temperature is lower.

Herein, driving the first circulator when the temperature difference between the first space side and the second space side exceeds the predetermined threshold such that the first circulator at the point where the temperature difference is measured can allow the first or second cooling fluid of the first space side or the second space side where the temperature is lower, to flow into the second space side or the first space side where the temperature is higher may further include selecting a point having the largest temperature difference when the point at which the temperature difference is measured is a plurality of points, when the temperature difference between the first space side and the second space side exceeds the predetermined threshold.

In addition, determining whether the temperature difference between the first space side and the second space side exceeds the predetermined threshold may further include measuring the temperature of the first cooling fluid in the first space side and the temperature of the second cooling fluid in the second space side in real time at a plurality of points where the circulator for allowing the first space side and the second space side to communicate with each other is coupled, and for measuring the difference therebetween.

According to an exemplary embodiment of the present disclosure, an immersion cooling module may include a receiving unit having a first space that contains a first fluid and a second space that contains a second fluid, the first and second spaces being separated by a support unit. The module may further include the support unit and a plurality of battery cells spaced apart from one another, each battery cell being coupled to the support unit such that a first portion of the battery cell is immersed in the first fluid and a second portion of the battery cell is immersed in the second fluid. In addition, at least one circulator may be coupled to the support unit and configured to control a flow of the first and second fluids between the first and second spaces, thereby controlling temperatures of the first and second fluids.

Herein, the at least one circulator may include at least one circulator disposed between each pair of adjacent battery cells.

The features and advantages of the embodiments of the present disclosure will become more apparent with the following detailed description based on the accompanying drawings.

the terms or words used in the present specification and claims should not be interpreted in a conventional and dictionary sense, but should be construed in accordance with the meaning and concept corresponding to the technical spirit of the present disclosure based on the principle that the inventor can appropriately define the concept of the term to describe his or her invention in the best way.

According to an embodiment of the present disclosure, there is an advantageous effect of maximizing the cooling efficiency according to the flow direction of the cooling fluid.

In addition, there is an advantageous effect of controlling the flow of the cooling fluid according to the temperature of the cooling fluid, the rise in temperature of the object to be cooled, and the degree of cooling, by adjusting the flow direction of the cooling fluid.

In addition, there is an advantageous effect of reducing power consumption by increasing the overall energy efficiency of devices and of reducing the carbon emissions associated with the operation of related devices, by improving the cooling effect according to the flow direction of the cooling fluid and effectively controlling the flow direction of the cooling fluid to maximize the cooling efficiency.

### BRIEF DESCRIPTION OF THE DRAWINGS

FIG. 1 is a schematic cross-sectional view of an immersion cooling module according to an embodiment of the present disclosure.

FIG. 2 is an enlarged view of part A of FIG. 1.

FIG. 3 is a schematic diagram of a configuration of a circulator according to an embodiment of the present disclosure.

FIG. 4 is a flowchart illustrating a control method of an immersion cooling module according to an embodiment of the present disclosure.

FIG. 5 is a view illustrating a first operation of a control method of an immersion cooling module according to an embodiment of the present disclosure.

FIG. 6 is a view illustrating a second operation of a control method of an immersion cooling module according to an embodiment of the present disclosure.

### DETAILED DESCRIPTION OF THE DISCLOSURE

The terminology used in describing the embodiments of the present disclosure is intended solely for illustrative purposes and should not be construed as limiting the scope of the disclosure. It should be noted that singular expressions include plural expressions unless otherwise specified in the context.

When assigning reference numbers to components in drawings, identical components may be assigned the same reference numbers whenever possible, even when appearing on different drawings, and similar components may be assigned similar reference numbers.

The drawings may be schematic or exaggerated for the purpose of describing the embodiments. In the present specification, expressions such as “have”, “may have”, “include”, or “may include” may refer to the presence of the corresponding feature (e.g., a numerical value, function, operation, or component such as a part) and may not exclude the presence of additional features.

The terms such as “one,” “other,” “another,” “first,” and “second” may be used to distinguish one component from another component, and the components may not be limited by the terms.

Hereinafter, an embodiment of the present disclosure will be described in detail with reference to the accompanying drawings.

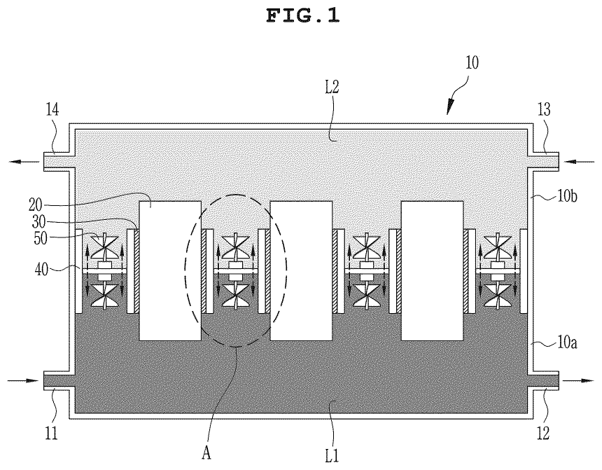

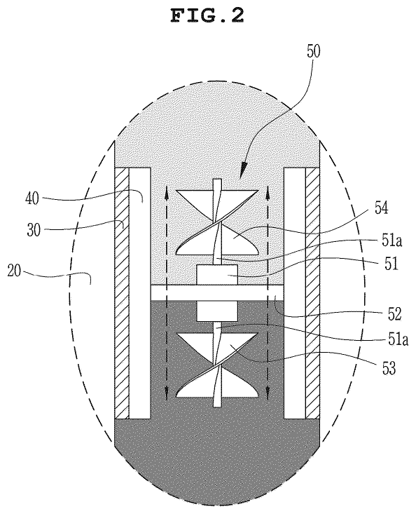

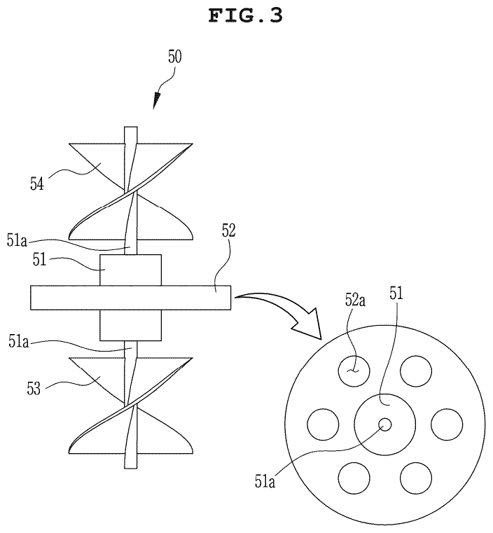

FIG. 1 is a schematic cross-sectional view of an immersion cooling module according to an embodiment of the present disclosure, FIG. 2 is an enlarged view of part A of FIG. 1, and FIG. 3 is a schematic diagram of a configuration of a circulator 50 according to an embodiment of the present disclosure.

An immersion cooling module according to an embodiment of the present disclosure may include a receiving unit 10 in which a cooling fluid L1, L2 is contained and in which a battery cell is immersed. The receiving unit 10 may include a support unit 40 which partitions the receiving unit 10 into a first space 10a, in which a first cooling fluid L1 is contained, at one side and a second space 10b, in which a second cooling fluid L2 is contained, at the other side, and to which at least one battery cell 20 is coupled. The receiving unit 10 may further include a circulator 50 coupled to the support unit 40 to be operated such that the first cooling fluid L1 and the second cooling fluid L2 can flow with each other by connecting the first space 10a and the second space 10b of the support unit 40 to communicate with each other.

As illustrated in FIG. 1, the receiving unit 10 may form a space in which the cooling fluids L1, L2 are contained and in which a plurality of the battery cells 20 is immersed. Herein, the object immersed in the cooling fluids L1, L2 may be described as the battery cell 20 by way of example, but it is noted that a large-sized device or system other than the battery cell 20 or battery cells 20 which is included in a data center, can be applied in consideration of the size or specifications of the immersion cooling module, for example.

As illustrated in FIG. 1, the support unit 40 may be coupled inside the receiving unit 10 to partition upper and lower spaces of the receiving unit 10. The coupling form of the support unit 40 and the shape of the support unit 40 may not be limited to those illustrated, and are appropriately arranged to form a flow of the cooling fluid L1, L2 in the two spaces.

In the embodiment of FIG. 1, the support unit 40 may be coupled to the receiving unit 10 to partition a first space 10a, which is a lower space, and a second space 10b, which is an upper space. The first space 10a and the second space 10b may be formed as physically separated spaces, and allow the cooling fluids L1, L2, that is, the first cooling fluid L1 and the second cooling fluid L2, to individually flow into each space.

As illustrated in FIG. 1, a first inlet unit 11 through which the first cooling fluid L1 flows in one end of the first space 10a and a first outlet unit 12 through which the first cooling fluid L1 is discharged in the other end may be respectively formed at one side and the other side, to form the flow direction of the cooling fluids L1, L2.

Separately from this, an inlet unit and an outlet unit may be respectively formed in the second space 10b in a way opposite to those of the first space 10a. That is, a second inlet unit 13 through which the second cooling fluid L2 is introduced may be formed in the second space 10b in a way opposite to the first inlet unit 11 of the first space 10a, and a second outlet unit 14 through which the second cooling fluid L2 is discharged may be formed in the second space 10b in a way opposite to the first outlet unit 12 of the first space 10a.

The first cooling fluid L1 and the second cooling fluid L2 may be different heterogeneous cooling fluids L1, L2, but may also be the same homogeneous cooling fluids L1, L2.

When cooling fluids L1, L2 which are different from each other are applied, it is possible to appropriately select and apply relevant conditions, such as the arrangement of the physical spaces of the first space 10a and the second space 10b, the possibility of mixing between the fluids for allowing the first cooling fluid L1 and the second cooling fluid L2 to be smoothly mixed and flow, the difference in specific gravity between the fluids, and the like.

The cooling fluids L1, L2 may be applied by a non-conductive fluid that prevents electricity from flowing through the immersed electronic product, battery cell 20, server, and the like. For example, the cooling fluids L1, L2 may include base oils. The base oil may include a mineral oil, and may include Poly Alpha Olefin (PAO) and/or an ester base oil. However, the cooling fluids L1, L2 of the present disclosure may not be limited thereto, and may include all fluids capable of cooling a battery cell.

The support unit 40 may be formed to partition an inner space of the receiving unit 10 into the first space 10a and the second space 10b, and to allow the battery cell 20 to be coupled thereto. In the present disclosure, an embodiment in which the battery cell 20 is coupled to the support unit is illustrated, but the support unit 40 may be physically fixedly coupled to other devices, such as coolable electronic devices or servers, so that immersion cooling can be effectively performed inside the receiving unit 10.

Since the battery cell 20 to be cooled is coupled to the support unit 40 and disposed at each fixed position, the flow direction of the first cooling fluid L1 and the second cooling fluid L2 may be appropriately adjusted according to the temperature or the flow state of the cooling fluids L1, L2 at each point, or mixed flow of the cooling fluids L1, L2 may be induced, thereby effectively cooling the battery cell 20 disposed at each point.

Herein, a porous moisture-absorbing member 30 may be coupled to a coupling surface where the battery cell 20 and the support unit 40 are coupled. By coupling the porous moisture-absorbing member 30, a buffering effect is possible at the coupling portion between the support unit and the battery cell 20, so it is possible to appropriately respond to the expansion or physical deformation of the battery cell 20. In addition, there is an effect that as the cooling fluids L1, L2 are naturally absorbed into the porous moisture-absorbing member 30, the outer circumferential surface of the battery cell 20 can be cooled, and the battery cell 20 can be cooled again through the latent heat generated in the process in which the cooling fluids L1, L2 are vaporized due to the heat generated from the battery cell 20.

The circulator 50 may be driven by being coupled to at least one point on the support unit so that the first cooling fluid L1 and the second cooling fluid L2 of the first space 10a and the second space 10b partitioned by the support unit 40 can be mutually mixed and flowed.

As illustrated in FIG. 2, the circulator 50 may include a first screw 53 immersed in the first cooling fluid L1 of the first space 10a and a second screw 54 immersed in the second cooling fluid L2 of the second space 10b.

The first screw 53 and the second screw 54 may be coupled to rotation shaft 51a, and the rotation shaft 51a may be coupled to the driving device 51 to be rotatably driven, thereby enabling the flow direction of the first cooling fluid L1 and the second cooling fluid L2 to be determined according to the rotation direction.

Specifically, as illustrated in FIG. 3, the circulator 50 may include a first screw 53 formed in a region of the first space 10a, a second screw 54 formed in a region of the second space 10b, a rotation shaft 51a in which the first screw 53 and the second screw 54 are coupled, and a support plate 52 having at least one through-hole 52a formed therein in which the first space 10a and the second space 10b are connected to communicate with each other by allowing the rotation shaft 51a to be rotatably coupled to a driving device 51 and the driving device 51 to be coupled to the support unit 40.

That is, the support plate 52 may be coupled to the support unit 40 at a boundary portion between the first space 10a and the second space 10b, and the driving device 51 may be coupled to the support plate 52. The support plate 52 may also be considered part of the support unit 40. That is, the support unit 40 with the support plates 52 and the battery cells 20 partition the receiving unit to the first and second spaces 10a and 10b. The driving device 51 may include, for example, a motor driving device, and additionally, various other rotation driving devices may be applied to rotatably drive the rotation shaft 51a.

The driving device 51 may be coupled to the support plate 52, and the driving device 51 may be coupled to enable the rotation shaft 51a to rotate so that the first screw 53 and the second screw 54 can be rotated.

By simultaneously driving the first screw 53 and the second screw 54 in a direction in which the rotation shaft 51a rotates, the first cooling fluid L1 may flow from the first space 10a to the second space 10b or the second cooling fluid L2 may flow from the second space 10b to the first space 10a in the opposite direction.

The movement directions of the cooling fluids according to the rotation direction of the first screw 53 and the second screw 54 may be formed to be the same, so that the flow of the cooling fluids L1, L2 between the first and second spaces 10a and 10b may be controlled by adjusting the rotation direction of the single rotation shaft 51a.

As illustrated in FIG. 3, the support plate 52 may be formed with at least one through-hole 52a that enables the first space 10a and the second space 10b to be connected and communicate with each other when the first screw 53 and the second screw 54 are driven and the cooling fluids L1, L2 flow. The cooling efficiency may be maximized by adjusting the amount or speed of the cooling fluids L1, L2 introduced per unit time depending on the shape or size of the through-hole 52a.

The through-holes 52a of the support plate 52 may be formed as a plurality of circular through-holes 52a spaced apart from each other along the circumferential direction of the support plate 52. The through-holes 52a may be formed to have the same or different shape. For example, the through holes 52a may have shapes different from each other by varying their diameters. In an embodiment, as illustrated in FIG. 3 the through holes 52a may have a circular shape and same diameters. It is possible to improve the cooling efficiency by determining the size and number of appropriate through-holes 52a depending on the arrangement position of the circulator 50, that is, the temperature of the cooling fluids L1, L2 in accordance with the flow of the first cooling fluid L1 and the second cooling fluid L2, or the degree of heat generated by the battery cell 20 coupled to each point of the support unit 40.

It is possible to control a flow rate of the cooling fluids L1, L2 passing through the support plate 52 per unit time by adjusting the area of the through-hole 52a through which the cooling fluid L1, L2 flows mutually between the first space 10a and the second space 10b, and it is also possible to control a total amount of the cooling fluids L1, L2 passing per unit time by adjusting the total area of the through-hole 52a.

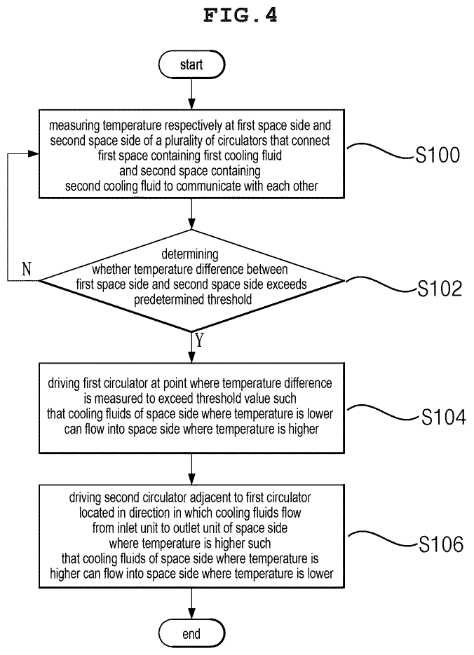

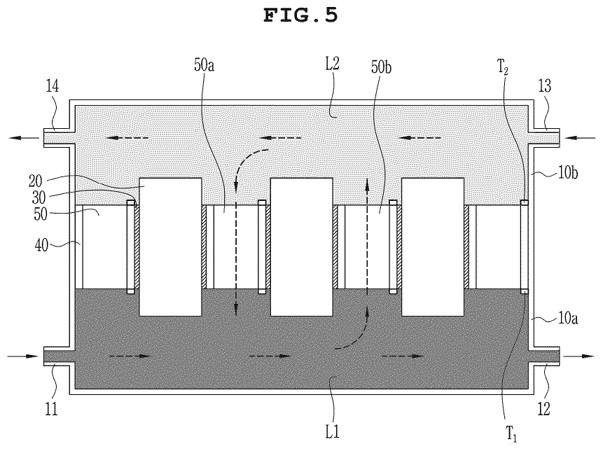

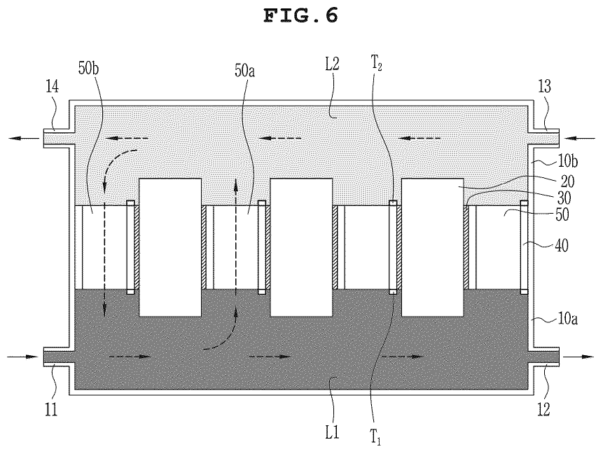

FIG. 4 is a flowchart illustrating a control method of an immersion cooling module according to an embodiment of the present disclosure, FIG. 5 is a view illustrating a first operation of a control method of an immersion cooling module according to an embodiment of the present disclosure, and FIG. 6 is a view illustrating a second operation of a control method of an immersion cooling module according to an embodiment of the present disclosure.

A control method for an immersion cooling module according to an embodiment of the present disclosure may include measuring a temperature respectively at a first space 10a side and a second space 10b side of a plurality of circulators 50 that connect the first space 10a containing a first cooling fluid L1 and the second space 10b containing a second cooling fluid L2 to communicate with each other (operation S100), determining whether a temperature difference between the first space 10a side and the second space 10b side exceeds a predetermined threshold (operation S102), driving a first circulator 50a when the temperature difference between the first space 10a side and the second space 10b side exceeds the predetermined threshold such that the first circulator 50a at the point where the temperature difference is measured can allow a first or second cooling fluid L1, L2 of the first space 10a side or the second space 10b side where the temperature is lower, to flow into the second space 10b side or the first space 10a side where the temperature is higher (operation S104), and driving a second circulator 50b that is adjacent to a direction in which the second cooling fluid L2 or the first cooling fluid L1 flows from the second inlet unit 13 to the second outlet unit 14 or from the first inlet unit 11 to the first outlet unit 12 in the second space 10b side or the first space 10a side where the temperature is higher such that the second cooling fluid L2 or the first cooling fluid L1 can flow in a direction from the second space 10b side or the first space 10a side where the temperature is higher to the first space 10a side or the second space 10b side where the temperature is lower (operation S106).

As illustrated in FIG. 5, first, the temperatures of the first space 10a side and the second space 10b side of at least one circulator 50 that connects the first space 10a containing the first cooling fluid L1 and the second space 10b containing the second cooling fluid L2 to communicate with each other may be measured using a first temperature sensor (T1) and a second temperature sensor (T2), respectively.

In an embodiment of the present disclosure, the flow direction of the first cooling fluid L1 in the first space 10a and the flow direction of the second cooling fluid L2 in the second space 10b may be designed to be mutually opposite. The temperature of the cooling fluids L1, L2 may be lowest at the inlet portion, and as the flow direction progresses while gradually cooling the battery cell 20, the temperature of the cooling fluids L1, L2 may gradually increase, thereby reducing the cooling efficiency.

Accordingly, by allowing the first cooling fluid L1 and the second cooling fluid L2 to flow in opposite directions in the first space 10a and the second space 10b, respectively, it is possible to maximize the cooling efficiency of the battery cell 20 that is immersed within the receiving unit 10.

By measuring the temperature difference between the first cooling fluid L1 and the second cooling fluid L2 at the point where the circulator 50 is coupled so that the first space 10a and the second space 10b are connected to communicate with each other, it is possible to effectively check the heat generation state or the cooling efficiency state of the battery cell 20. In addition, since the temperature difference at the point where the circulator 50 is disposed can be measured, it is desirable to install and couple the circulator 50 at appropriate positions and intervals in consideration of this when arranging the circulator 50.

Next, according to an embodiment of the present disclosure a determination may be made as to whether a measured value of a temperature difference between the first space 10a side and the second space 10b side exceeds a predetermined threshold.

A temperature range of the first cooling fluid L1 according to a flow direction of the first cooling fluid L1 and a temperature range of the second cooling fluid L2 according to a flow direction of the second cooling fluid L2 may be formed within a predetermined range. Accordingly, when a mutual temperature difference between the first cooling fluid L1 and the second cooling fluid L2 at each position exceeds a threshold value, it can be determined that the heat generation of the battery cell 20 at the corresponding position, in whole or in part, has rapidly increased. Since the battery cell extends across both the first space 10a side and the second space 10b side, the temperature difference between the first cooling fluid L1 and the second cooling fluid L2 of the first space 10a and the second space 10b may be rapidly increased due to a heat generation problem at a position close to the boundary surface.

Herein, the threshold value for the temperature difference between the first space 10a side and the second space 10b side may be set differently at each point in the direction in which the cooling fluid flows.

When the measured value of the temperature difference between the first space 10a side and the second space 10b side exceeds the predetermined threshold, the first circulator 50a may operate at the point where the temperature difference is measured to exceed the threshold value.

That is, the first circulator 50a at the point where the temperature difference is measured may drive the first cooling fluid L1 or the second cooling fluid L2 at the first space 10a side or the second space 10b side, where the temperature is lower, to flow toward the second space 10b side or the first space 10a side, where the temperature is higher.

By allowing the cooling fluids L1, L2 on the space side where the temperature is lower, to flow toward the space side where the temperature is relatively higher, the temperature difference between the first space 10a and the second space 10b can be alleviated to the maximum extent, thereby maintaining a balance in cooling and effectively responding to heat generation at a specific point.

Next, a second circulator 50b that is adjacent to a direction in which the second cooling fluid L2 or the first cooling fluid flows (L1) from the second inlet unit 13 to the second outlet unit 14 or from the first inlet unit 11 to the first outlet unit 12 in the second space 10b side or the first space 10a side where the temperature is higher may be driven such that the second cooling fluid L2 or the first cooling fluid L1 can flow in a direction from the second space 10b side or the first space 10a side where the temperature is higher to the first space 10a side or the second space 10b side where the temperature is relatively lower.

That is, when the first circulator 50a is driven, the second circulator 50b, which is adjacent to the direction in which the cooling fluids L1, L2 flow within the space into which they are introduced, may be driven as well when the cooling fluids L1, L2 are introduced in the direction of flow—that is, the direction in which the cooling fluids L1, L2 move from a space with a relatively lower temperature into a space with a higher temperature.

For example, as illustrated in FIG. 5, the first cooling fluid L1 may be contained in the first space 10a at a lower portion of the support unit 40, and the second cooling fluid L2 may be contained in the second space 10b at an upper portion of the support unit 40.

When the temperature of the first cooling fluid L1 in the first space 10a is higher than the temperature of the second cooling fluid L2 in the second space 10b at the point where the first circulator 50a is initially coupled, and the temperature difference exceeds a threshold value, the first circulator 50a may operate.

The first circulator 50a may introduce the second cooling fluid L2 of the second space 10b where the temperature is relatively lower into the first space 10a where the temperature is higher. In this way, the second cooling fluid L2 may be introduced into the first space 10a and mixed with the first cooling fluid L1, thereby lowering the overall temperature of the cooling fluids L1, L2.

In this case, the second circulator 50b that is adjacent to the first circulator 50a in a direction from the first inlet unit 11 to the first outlet unit 12, that is, in the direction in which the first cooling fluid L1 flows in the first space 10a where the temperature is relatively higher, may be driven. The second circulator 50b may circulate the cooling fluids L1, L2 in the opposite direction of the first circulator 50a, from the first space 10a toward the second space 10b, thereby inducing the overall circulation of the cooling fluids L1, L2 and improving the cooling efficiency.

In addition, as illustrated in FIG. 6, the first circulator 50a may operate when the temperature of the first cooling fluid L1 in the first space 10a is lower than the temperature of the second cooling fluid L2 in the second space 10b at the point where the first circulator 50a is coupled, and the temperature difference exceeds the threshold value.

The first circulator 50a may introduce the first cooling fluid L1 of the first space 10a where the temperature is relatively lower into the second space 10b where the temperature is higher. In this way, the first cooling fluid L1 may be introduced into the second space 10b and mixed with the second cooling fluid L2, thereby lowering the overall temperature of the cooling fluids L1, L2.

In this case, the second circulator 50b that is adjacent to the first circulator 50a in a direction from the second inlet unit 13 to the second outlet unit 14, that is, in the direction in which the second cooling fluid L2 flows in the second space 10b where the temperature is relatively higher, may operate. The second circulator 50b may circulate the cooling fluids L1, L2 from the second space 10b toward the first space 10a in the opposite direction of the first circulator 50a, thereby inducing the overall circulation of the cooling fluids L1, L2 and improving the cooling efficiency.

As described above, the embodiments of the present disclosure have been described in detail through specific embodiments. These embodiments are intended to specifically illustrate the concepts of the present disclosure, and the embodiments are merely illustrative and do not limit the scope of the appended claims. It will be apparent to those skilled in the art that various modifications and variations to the embodiments are possible within the scope and technical spirit of the present disclosure. Such modifications and variations should be construed to fall within the scope of the appended claims.

What is claimed is:

1. An immersion cooling module, the module comprising:
a receiving unit in which a cooling fluid is contained the cooling fluid comprising a first cooling fluid and a second cooling fluid, and a battery cell that is immersed in the cooling fluid;
a support unit which partitions the receiving unit into a first space in which the first cooling fluid is contained at one side and a second space in which the second cooling fluid is contained at the other side, and to which at least one battery cell is coupled; and
a circulator coupled such that the first space at one side of the support unit and the second space at the other side of the support unit are connected to communicate with each other, thereby allowing the first cooling fluid and the second cooling fluid to flow with each other.

2. The module of claim 1, further comprising when the battery cell is coupled to the support unit, a porous moisture-absorbing member between a coupling surface of the support unit and the battery cell.

3. The module of claim 1, wherein the circulator comprises:
a first screw formed in a region of the first space;
a second screw formed in a region of the second space;
a rotation shaft in which the first screw and the second screw are coupled; and
a support plate having at least one through-hole formed therein in which the first space and the second space are connected to communicate with each other by allowing the rotation shaft to be rotatably coupled to a driving device and the driving device to be coupled to the support unit.

4. The module of claim 1, further comprising:
a first inlet unit through which the first cooling fluid is introduced in one end of the first space;
a first outlet unit through which the first cooling fluid is discharged in the other end of the first space;
a second inlet unit through which the second cooling fluid is introduced in one end of a direction in which the first outlet unit of the second space is formed; and
a second outlet unit through which the second cooling fluid is discharged in the other end of the direction in which the first inlet unit of the second space is formed.

5. The module of claim 3, wherein the at least one through-hole of the support plate is formed as a plurality of circular through-holes along a circumferential direction of the support plate.

6. A control method for an immersion cooling module, the method comprising:
measuring a temperature respectively at a first space side and a second space side of a plurality of circulators that connect a first space containing a first cooling fluid and a second space containing a second cooling fluid to communicate with each other;
determining whether a temperature difference between the first space side and the second space side exceeds a predetermined threshold;
driving a first circulator when the temperature difference between the first space side and the second space side exceeds the predetermined threshold such that the first circulator at a point where the temperature difference is measured can allow the first or second cooling fluid of the first space side or the second space side where the temperature is lower, to flow into the second space side or the first space side where the temperature is higher, and
driving a second circulator adjacent to a direction in which the second cooling fluid or the first cooling fluid flows from a second inlet unit to a second outlet unit or from a first inlet unit to a first outlet unit in the second space side or the first space side where the temperature is higher such that the second cooling fluid or the first cooling fluid can flow in a direction from the second space side or the first space side where the temperature is higher to the first space side or the second space side where the temperature is lower.

7. The method of claim 6, wherein driving the first circulator when the temperature difference between the first space side and the second space side exceeds the predetermined threshold such that the first circulator at the point where the temperature difference is measured allows the first or second cooling fluid of the first space side or the second space side where the temperature is lower, to flow into the second space side or the first space side where the temperature is higher, further comprises:
selecting a point having the largest temperature difference when the point at which the temperature difference is measured includes a plurality of points, when the temperature difference between the first space side and the second space side exceeds the predetermined threshold.

8. The method of claim 6, wherein determining whether the temperature difference between the first space side and the second space side exceeds the predetermined threshold further comprises:
measuring the temperature of the first cooling fluid in the first space side and the temperature of the second cooling fluid in the second space side in real time at a plurality of points where the circulator for allowing the first space side and the second space side to communicate with each other is coupled, and measuring the difference therebetween.

9. An immersion cooling module, the module comprising:
a receiving unit comprising a first space containing a first fluid and a second space containing a second fluid, the first and second spaces being separated by a support unit;
the support unit;
a plurality of spaced apart battery cells, each battery cell being coupled to the support unit so that one part of the battery cell is immersed in the first fluid and a second part of the battery cell is immersed in the second fluid; and
and at least one circulator coupled to the support unit and configured to control a flow of the first and second fluids between the first and second spaces for controlling the temperature of the first and second fluids.

10. The immersion cooling module of claim 9, wherein the at least one circulator includes at least one circulator between each pair of adjacent battery cells.
